(19) United States
(12) Patent Application Publication
(10) Pub. No.: US 2007/0002322 A1
(43) Pub. Date: Jan. 4, 2007

(54) Image inspection method

(76) Inventors: Yan Borodovsky, Portland, OR (US); Wen-Hao Cheng, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,783

(22) Filed: Jun. 30, 2005

(51) Int. Cl. G01B 11/00

(52) U.S. Cl. 356/394

(57) ABSTRACT

Embodiments of the invention provide methods and apparatuses for detecting defects and contaminants on reticles. For one embodiment of the invention, either one or both of an aerial image database and a resist image database are created and compared to an actual scanned mask die image. For one embodiment of the invention, the comparison is used to identify defects of contaminants on the reticle. For one embodiment of the invention, a decision as to whether the reticle should be discarded or cleaned and repaired is made based upon the determined defects or contaminants.

### FIELD

Embodiments of the invention relate generally to the field of photolithography and more specifically to methods and apparatuses for image of static or dynamic mask inspection.

### BACKGROUND

The process of photolithography in semiconductor device fabrication typically involves a combination of etching, chemical deposition, and chemical treatment in repeated steps on a substrate. The substrate may be comprised of, for example, a silicon wafer. For this purpose a plate with patterns printed on it, called a photomask (reticle), is customary used together with an illumination source and projection optics to shine light on specific parts of the photoresist on a wafer. The desired pattern is projected onto the wafer by, for example, a conventional stepper or scanner. The stepper as well as a scanner is an optical system containing illumination source that projects the mask (reticle) pattern onto the wafer to image the desired pattern.

A typical stepper has a lens that can image a 22 mm×22 mm field with sub-micron resolution. A typical scanner has a lens that can image 26×8 mm field statically and 26×34 mm field when scanning to reproduce full image of the reticle on the wafer. Each imaging field can contain one or multiple products.

Subsequently, the photoresist that was not exposed to light and the metal underneath are etched away with a chemical treatment. Underlying thin film such as isolating layer or conductive layer of the thin film needed for electrical functionality of device is etched through openings in photoresist using a different chemical treatment, and all that remains of conducting or isolating thin film is the same shape as the reticle. A portion of a typical lithography procedure would begin with manufacturing of the mask (reticle, photomask) by depositing a layer of conductive metal several nanometers (nm) thick on the substrate. A layer of photoresist is applied on top of the metal layer. The solubility of photoresist to specific solvent of is selectively altered by exposing it in specific places to radiation as per database layout.

An Image of the database is reproduced as the latent image in photoresist through the use of either electron beam or optical mask writers which chemically alters exposed resist area so it become solvable in a particularly chosen solvent (for positive resists) and insoluble for negative tone resists. Mask is exposed to solvent, Resist is chemically altered areas is dissolved (positive resist) and thin metal film is etched through openings in the resist. When semiconductor devices are fabricated using photolithography, it is critical to product integrity that the reticle is replica to the database from which it was generated with least possible deviations from it due to manufacturing defects and imperfections as possible as well as it is free of contaminants and obstructions introduced during manufacturing and handling of the mask (e.g., defects or contaminating particulate matter) as possible. For high volume manufacturing, reticle defects or contamination can result in expensive losses in product yield, and loss of time to bring products to market. Once the reticle is fabricated it is inspected to detect patterned defects and contamination. Defects once detected can often be repaired, and contaminants can typically be removed through cleaning.

One method used to detect reticle defects or contamination is a die-to-die (D:D) comparison method. The D:D comparison method involves comparing two identical die from an imaging field. For example, an optical inspection tool may be used to scan the reticle to produce optical image of the reticle under inspection. The optical imaging of the reticle is stored in a digital processing system (DPS). Database consisting of an aerial image of each die is created. The aerial images of identical die are compared using, for example, a digital image processing system. A significant random defect on the reticle will cause the aerial image of one die to have distinguishable differences in comparison to the aerial image of an identical die as improbability of having two identical random defects located in the same relative position on the pattern of two different dies is vanishingly small. A digital image processing system employing various techniques (e.g., pattern recognition) can automate the determination of multiple reticle defects or contaminants.

One disadvantage of the D:D comparison method is that it is not applicable to single die imaging fields or systematic defects introduced by mask manufacturing resulting in substantial deviations from intended mask layout on all identical dies in same relative locations such as unresolved small serif (or alike) not patterned correctly due to the loss of resolution of patterning tool involved in mask manufacturing for example. Current optical inspection methodologies use an inspection wavelength that is different (longer) than the radiation wavelength used with the mask in wafer exposure tool. For example, the ability to project a clear image of a very small feature onto the wafer is limited by the wavelength of the light that is used and the ability of the reduction lens system to capture enough diffraction orders off of the illuminated reticle. Current state of the art photolithography tools use deep ultraviolet (DUV) light with a wavelength of 193 nm, allowing patterning of feature with sizes on the order of 100 nm or even as small as 45 nm using techniques such as immersion photolithography.

Typical optical inspection methodologies use wavelengths that are greater than the wavelength of radiation used to pattern wafers. The longer inspection wavelengths could not accurately emulate mask features imaged on wafer.

### BRIEF DESCRIPTION OF THE DRAWINGS

The invention may be best understood by referring to the following description and accompanying drawings that are used to illustrate embodiments of the invention. In the drawings:

FIG. 1 illustrates a process by which reticle defects and contaminants on the reticle are identified and corrected in accordance with one embodiment of the invention;

FIG. 2 illustrates a process by which reticle defects and contaminants on the reticle are identified and corrected in accordance with another embodiment of the invention; and

FIG. 3 illustrates a system in accordance with yet another embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

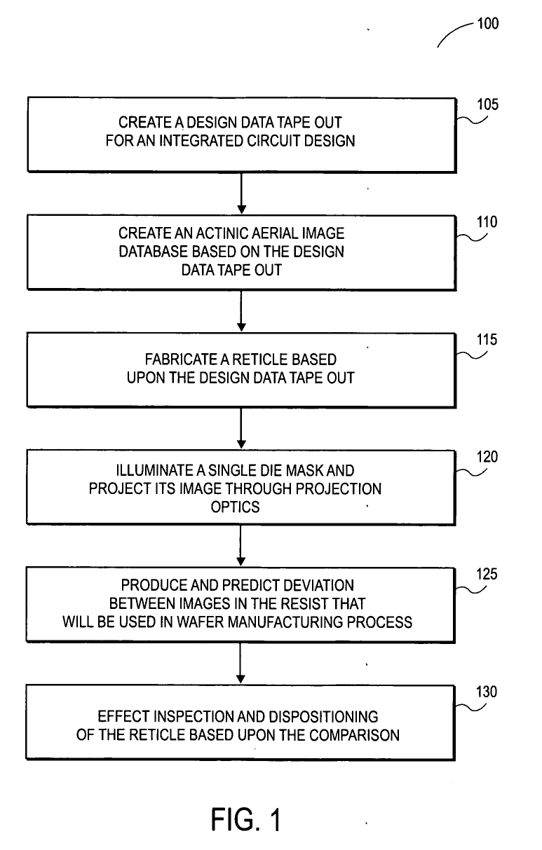

FIG. 1 illustrates a process by which reticle defects and contaminants on the reticle are identified and corrected in accordance with one embodiment of the invention. Process 100, shown in FIG. 1, begins at operation 105 in which the design data database is created. The design database is a verified functional description of the typically IC design or test pattern involved in IC design and development together with specified design constraints such as timing, area, and performance constraints.

The design database as drawn by circuit designer might be altered for purpose of enriching its content in a way that circumvent or substantially mitigate limitations of optical bandwidth of wafer imaging systems through the use of up or down sizing, Optical proximity corrections, phase shifting, use of sub-resolution scattering features and other known image enhancement methods employed on the mask that are know in the field. We will call that modified database tapeout database. It is that altered taped-out database that should be faithfully reproduced on a mask and it is deviation both in phase and intensity from that altered database that will constitute mask defect as a result of mask making and it is these deviation that first and foremost will constitute subject of investigation by use of inspection systems proposed. At operation 110 database containing aerial image representation of design tape-out database (AIC DB) in a far field (wafer plane) is created using lithography imaging modeling tools, from which the imaging model is calibrated from wafer resist image obtained under under illumination and imaging settings of the prohjection system and wafer resist process parameters to be used with mask under inspection.

At operation 115 the reticle is fabricated based upon the design tape-out database. The reticle is fabricated through methods known to those skilled in the art. For one embodiment, for example, the image for the reticle is originated from the design data tape-out data file. This data file is converted to a series of polygons and written onto a square fused quartz substrate covered with a layer of chrome using a photolithographic process. A beam of electrons is used to expose the pattern defined in the data file travels over the surface of the substrate in either a vector or raster scan manner. Where the photoresist on the mask is exposed, the resist can be etched away (for the case of positive photoresist) and underlying chrome can be etched away through resist opening by consecutive chrome etch operation, leaving a clear path for the light in the stepper/scanner systems to travel through. Mask manufacturing might involve additional mask making steps to pattern and etch additional features in underlying films or transparent substrate itself for purpose of controlling not only amplitude but phase of the light propagating through the “openings” on the mask.

At operation 115 referred mask is inserted for inspection in the tool that allows investigate far field aerial image of the mask at the wavelength, illumination and imaging conditions that will be used when this mask will be employed for image patterning in photosensitive media (resist) on the wafer.

At operation 120 a single die mask is illuminated and its image is projected through inspection tool optics as described above and resulting aerial image and its details is collected by means of inspection tool collection optics, detection and database storage of named optical inspection tool. Deviation of captured by inspection tool database (AIT DB) representing aerial image of the actual manufactured mask from one predicted by aerial image computed (AIC DB) is mask defect.

If upon comparison of uncovered deviations every discrepancy is within previously defined acceptable limits mask is considered “defect free” if some of the discrepancies exceed limits mask those discrepancies might be investigated further by use lithography modeling tools in a step 125.

In a step 125 modeling tools are used to produce and predict deviation between images in the resist that will be used in wafer manufacturing process using desired (AIC DB) and actual mask (AIT DB) aerial images and again comparing detected discrepancies against pre-determined tolerances.

If at step 125 all discrepancies are within tolerances mask is considered “defect free”, if some discrepancies are exceeding tolerance range mask considered to be defective.

At operation 130 defect inspection and dispositioning are effected. The differences between the Scanned Mask Database image and the Aerial Database images are evaluated to determine which differences constitute reticle defects. For one embodiment of the invention, various image processing techniques (e.g., filtering or thresholding) are employed to make this determination. For example, the comparison of operation 125 may yield hundreds of thousands of differences, not all of which are significant enough to constitute a reticle obstruction that may be addressed. To avoid this, a threshold is determined, and those defects or contaminants above the threshold are evaluated under newly defined conditions. For one embodiment of the invention the inspection and disposition process is automated. Based on results of such evaluation mask is dispositioned as defect free if all discrepancies between SMD and ADB are below pre-established acceptance tolerances or or dispositioned to be defective if said tolerances are met.

For masks that are considered to be defective additional procedures involving inspection of identified defective areas by other analytical means need to be employed to identify nature, distribution and size of the defects to separate patterning defects from effect of contaminants such as particle or residue from cleaning solutions attached to mask surface.

Mask Defects that are of contaminant nature consecutive cleaning and inspection procedures might result in defect free mask.

Mask Defects that are of mask patterning defect nature might require further disposition as described below:

During wafer exposure, the interaction between the light and the photoresist could result in a mask image captured in the latent image on the resist on wafer that is different from the aerial image based imaging model. As feature sizes decrease, these differences might become significant. The way in which these differences are manifested is dependent upon the photoresist used, complexity of the mask and proximity to resolution limits of imaging system employed with the chosen illumination configuration.

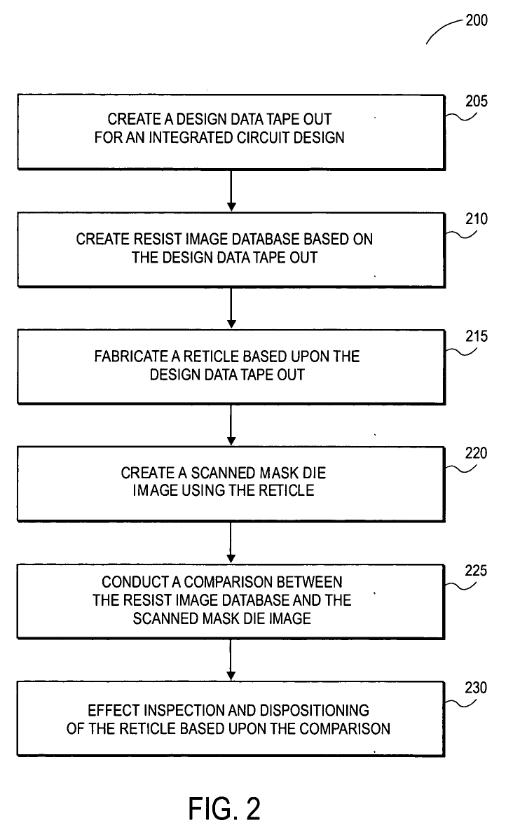

FIG. 2 illustrates a process by which reticle defects and contaminants on the reticle are identified and corrected in accordance with one embodiment of the invention.

Process 200 of FIG. 2 is similar to process 100 of FIG. 1. At operation 205 the design data tape-out is created.

At operation 210 a resist image database (RDB) is created. The RDB is calibrated using experimental resist images. For one embodiment of the invention, the RDB is created not only in consideration of the specific illumination conditions, but also in consideration of the photoresist used. Some aspects of the photoresist considered may include whether the photoresist is positive or negative, whether or not the photoresist is a chemically amplified resist, as well as the specific manufacturer of the photoresist.

Process 200 then continues in a similar manner as described above in reference to process 100 of FIG. 1. At operation 215 the reticle is fabricated based upon the design data tape-out.

At operation 220 the SMD image is created using an aerial image-based optical inspection tool.

At operation 225 the SMD image is compared to the RDB image and the differences are determined.

At operation 230 defect inspection and dispositioning are effected. The differences between the SMD image and the RDB image are evaluated to determine reticle defects and contaminants.

Reticle defects are those which produce deviations between SMD and RDB that exceed predetermined tolerances.

If deviations between SMD and RDB are within predetermined tolerances mask is considered to be defect free and ready for next mask making operation (pellicle attachment)

For masks that are considered to be defective (deviations between SMD and RDB exceeded predetermined tolerances) additional procedures involving inspection of identified defective areas by other analytical means need to be employed to identify nature, distribution and size of the defects to establish feasibility of repair of identified defects on the mask to complete defect free mask manufacturing.

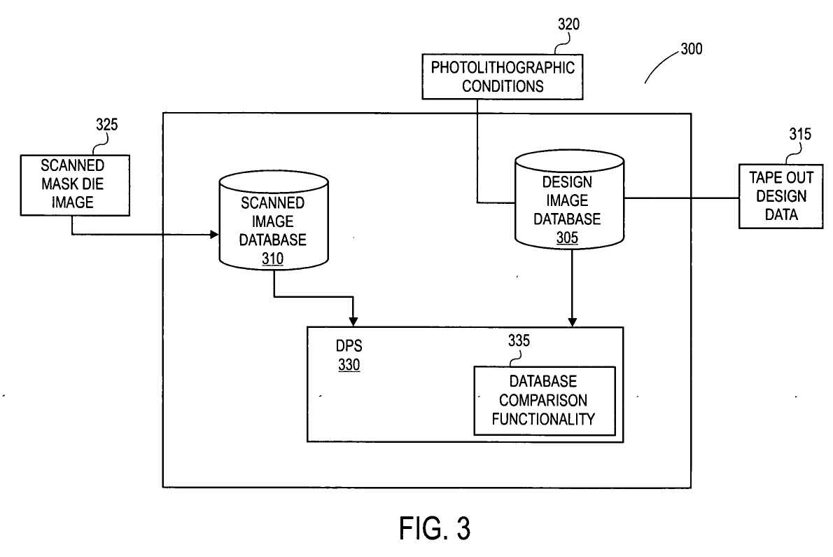

FIG. 3 illustrates a system in accordance with one embodiment of the invention.

System 300, shown in FIG. 3 includes a design image database 305 and a scanned image database 310. The design image database 305 may include an ADB, an RDB, or both. For one embodiment of the invention, the design image data base 305 is created from the IC tape out design data 315 in regard to various photolithographic conditions 320 (e.g., illumination conditions and photoresist properties).

The scanned image database 310 may be created from the scanned mask die image 325. System 300 also includes a digital processing system (DPS) 330, the general characteristics of which are described more fully below. The DPS 330 includes database comparison functionality 335 that effects a comparison between the information contained in the scanned image database and the information contained in the design image database. The differences between the two are further processed to indicate defects or contaminants on the reticle in accordance with one embodiment of the invention.

General Matters

Embodiments of the invention provide methods and apparatuses for detecting defects and contaminants on reticles. For one embodiment of the invention, either one or both of an aerial image database and a resist image database are created and compared to an actual scanned mask die image. For one embodiment of the invention, the comparison is used to identify defects of contaminants on the reticle. For one embodiment of the invention, a decision as to whether the reticle should be discarded or cleaned and repaired is made based upon the determined defects or contaminants.

In the above description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Although discussed in terms of IC design, embodiments of the invention are applicable to a variety of design types as will be apparent to those skilled in the relevant arts.

Embodiments of the invention include methods having various operations, many of which are described in their most basic form, but operations can be added to or deleted from any of the methods without departing from the basic scope of the invention.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose DPS selectively activated or reconfigured by a computer program stored in the DPS. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Various general-purpose DPSs may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-accessible medium includes any mechanism for storing or transmitting information in a form accessible by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
creating a design tape-out database pertaining to an integrated circuit design;
creating a database containing aerial image of design tapeout database under condition identical to imaging conditions mask containing design data tapeout will be used to pattern its image;
creating a data base containing collected image database based upon a collection of manufactured from said design database tapeout mask collected through the imaging system having critical to imaging identical optical characteristics such as wavelength, illumination shape and projection optics numerical aperture and pupil configuration identical to corresponding settings of exposure tool that will be employing said mask to image its content on photosensitive media on the wafer in process comparing the modeled aerial image design database to the experimentally collected image database.

2. The method of claim 1 further comprising:
determining reticle obstructions based upon the comparison.

3. The method of claim 2 wherein the obstructions are defects or contaminants.

4. The method of claim 1 wherein the design image data base is selected from the group consisting of an actinic aerial image database, a resist image database, and a combination thereof.

5. The method of claim 1 wherein the design image database is an actinic aerial image database created in consideration of specific illumination conditions corresponding to the reticle.

6. The method of claim 5 wherein the specific illumination conditions include illuminator shape, numerical aperture, and partial coherence.

7. The method of claim 1 wherein the design image database is a resist image database created in consideration of aspects of a specific photoresist.

8. The method of claim 7 wherein the aspects of the photoresist considered include positive, negative, chemically amplified, and manufacturer.

9. A system comprising:
a design data tape-out pertaining to an integrated circuit design;
a design image database based upon the design data tape out;
a scanned image database based upon a scanned mask die, the scanned mask die created from a reticle fabricated based on the design data tape-out; and
a processing system having a comparison functionality to compare the design image database to the scanned image database.

10. The system of claim 9 wherein reticle obstructions are determined by comparing the design image database to the scanned image database.

11. The system of claim 10 wherein the obstructions are defects or contaminants.

12. The system of claim 9 wherein the design image data base is selected from the group consisting of an actinic aerial image database, a resist image database, and a combination thereof.

13. The system of claim 9 wherein the design image database is an actinic aerial image database created in consideration of specific illumination conditions corresponding to the reticle.

14. The system of claim 13 wherein the specific illumination conditions include illuminator shape, numerical aperture, and partial coherence.

15. The system of claim 9 wherein the design image database is a resist image database created in consideration of aspects of a specific photoresist.

16. The system of claim 15 wherein the aspects of the photoresist considered include positive, negative, chemically amplified, and manufacturer.

17. A machine-accessible medium that provides instructions that, if executed by a processor, will cause the processor to perform a method comprising:
creating a design data tape-out pertaining to an integrated circuit design;
creating a design image database based upon the design data tape out;
creating a scanned image database based upon a scanned mask die, the scanned mask die created from a reticle fabricated based on the design data tape-out; and
comparing the design image database to the scanned image database.

18. The machine-accessible medium of claim 17 wherein the method further comprises:
determining reticle obstructions based upon the comparison.

19. The machine-accessible medium of claim 18 wherein the obstructions are defects or contaminants.

20. The machine-accessible medium of claim 17 wherein the design image data base is selected from the group consisting of an actinic aerial image database, a resist image database, and a combination thereof.

21. The machine-accessible medium of claim 17 wherein the design image database is an actinic aerial image database created in consideration of specific illumination conditions corresponding to the reticle.

22. The machine-accessible medium of claim 21 wherein the specific illumination conditions include illuminator shape, numerical aperture, and partial coherence.

23. The machine-accessible medium of claim 17 wherein the design image database is a resist image database created in consideration of aspects of a specific photoresist.

24. The machine-accessible medium of claim 23 wherein the aspects of the photoresist considered include positive, negative, chemically amplified, and manufacturer.
